(19) United States
(12) Patent Application Publication
(10) Pub. No.: US 2021/0196032 A1
(43) Pub. Date: Jul. 1, 2021

(54) MOBILE DEVICE HOLDER

(71) Applicant: Mitul Patel, Riverview, FL (US)

(72) Inventor: Mitul Patel, Riverview, FL (US)

(21) Appl. No.: 16/731,012

(22) Filed: Dec. 30, 2019

(51) Int. Cl. A45F 5/10; F16M 13/04

(52) U.S. Cl. CPC A45F 5/10; A45F 2200/0516; A45F 2200/0525; F16M 13/04

(57) ABSTRACT

Mobile devices may be unwieldy to hold or carry when not placed on a stable surface.

The present invention seeks to provide a solution to this problem(s) by providing a mobile device holder or carrier to securely fit around the hinge(s) of a mobile device to allow a user a hold the mobile device securely while not placed on a stable surface.

### FIELD OF THE INVENTION

The present invention relates to a mobile device holder for holding or carrying a mobile device.

### DESCRIPTION OF THE RELATED ART

FIG. 1 shows the front view of the mobile device holder (1) and an open (7) single hinge (6) mobile device (3), in accordance with a preferred embodiment of the present invention.

FIG. 2 shows the back view of the mobile device holder (1), and an open single hinge mobile device (3), and a mobile device holder enclosure (2)

FIG. 3 shows the side view of the mobile device holder (1), an open single hinge mobile device (3), and a mobile device holder enclosure (2)

FIG. 4 shows the front view of a multiple hinge (6) mobile device holder (4) and an open mobile device (3)

FIG. 5 shows the back view of a multiple hinge (6) mobile device holder (4), an open mobile device (3), and a mobile device holder enclosure (2)

FIG. 6 shows the back view of a mobile device in a holding mode, a user's hand (5) and fingers in between the mobile device holder and the mobile device (3), an open (7) mobile device (3), mobile device holder enclosure (2), and a mobile device holder (1)

FIG. 7 shows a closed (8) mobile device in a carrying mode, a user's hand (5) and fingers in between the mobile device holder and the mobile device (3), a closed (8) mobile device (3), and a mobile device holder (1)

### BACKGROUND

Mobile devices may be unwieldy to hold or carry when not placed on a stable surface.

Mobile devices used while not placed on a stable surface, such as when standing or walking, may be held or carried by a user's hand or arm, insecurely.

There isn't a product or method of securely carrying or holding a mobile device having a hinge(s).

### SUMMARY

The present invention seeks to provide a solution to this problem(s) by providing a mobile device holder or carrier to securely fit around the hinge(s) of a mobile device to allow a user a hold the mobile device securely while not placed on a stable surface.

The mobile device holder would be securely fit around the hinge(s) of a mobile device, while allowing a user's hand to slide between the mobile device holder and mobile device. This allows the user of a mobile device to wield it securely while not placed on a stable surface, such as, but not limited, when standing or walking. The mobile device can be wielded by user using the mobile device holder while it is opened or closed around the hinge(s).

In a preferred embodiment of the present invention, the mobile device holder would be made of strong, thin, and pliant materials that can be enclosed securely around the mobile device hinge(s) while allowing a mobile device to open and close unobstructed or minimal obstruction when wielded by a user for holding or carrying.

### BRIEF DESCRIPTION OF THE DRAWINGS

FIG. 1 In accordance with a preferred embodiment of the present invention, the mobile device holder is fit around the hinge of the mobile device while not obstructing the functioning features of the mobile device.

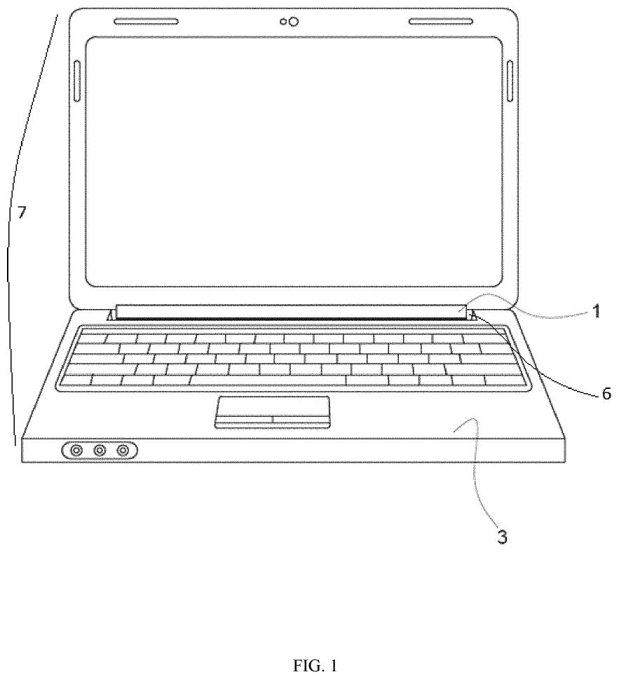

FIG. 2 In accordance with a preferred embodiment of the present invention, a hook and loop enclosure of the mobile device holder is shown to allow for adjustments for a user's hand to slide between the mobile device and the mobile device holder.

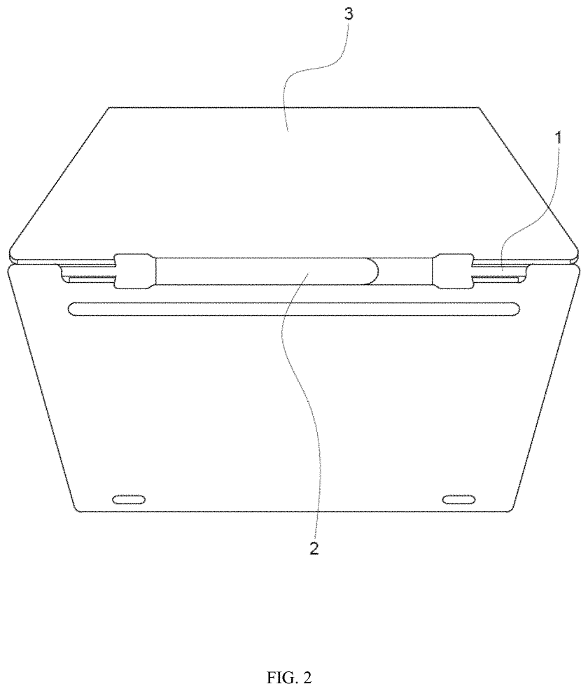

FIG. 3 The side view provides a perspective of how the mobile device and the mobile device holder are fit securely from the front to the back of the mobile device around the hinge(s).

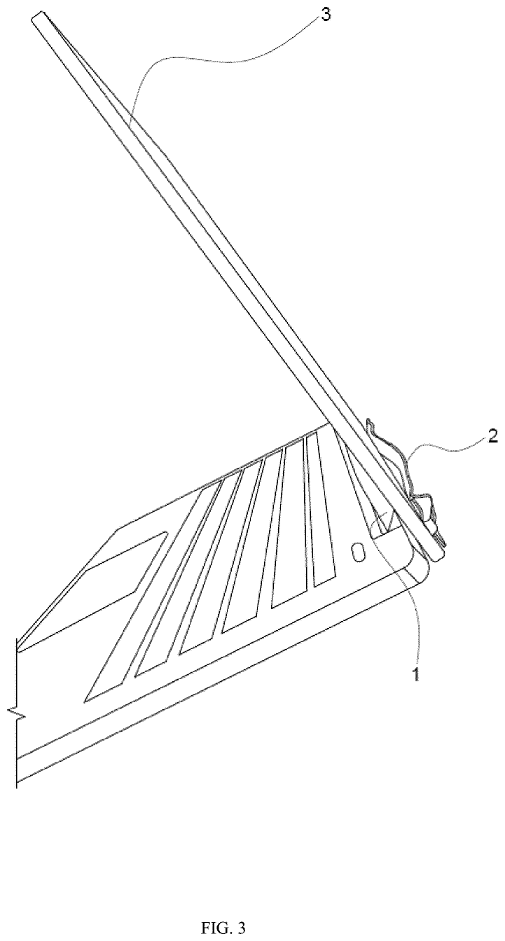

FIG. 4 Shows how a multiple hinge mobile device can be secured with a mobile device holder. The mobile device holder is shown latched to individual hinges of the mobile device.

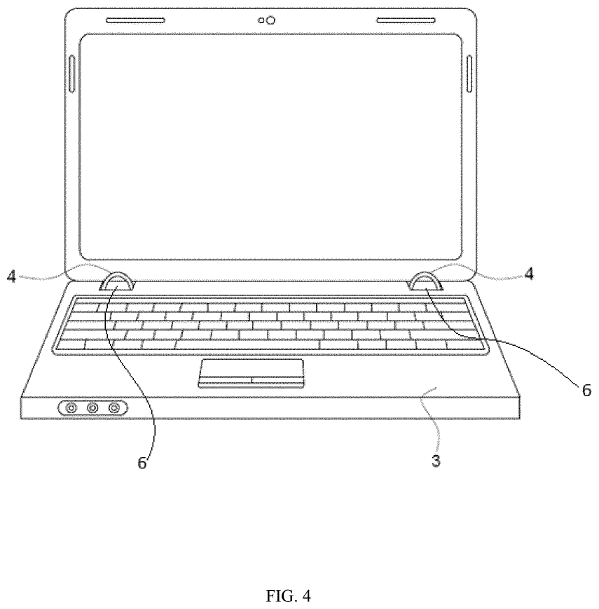

FIG. 5 A hook and loop enclosure of the mobile device holder is shown to allow for adjustments for a user's hand to slide between the multiple hinge mobile device and mobile device holder. The mobile device holder is shown latched to individual hinges of the mobile device.

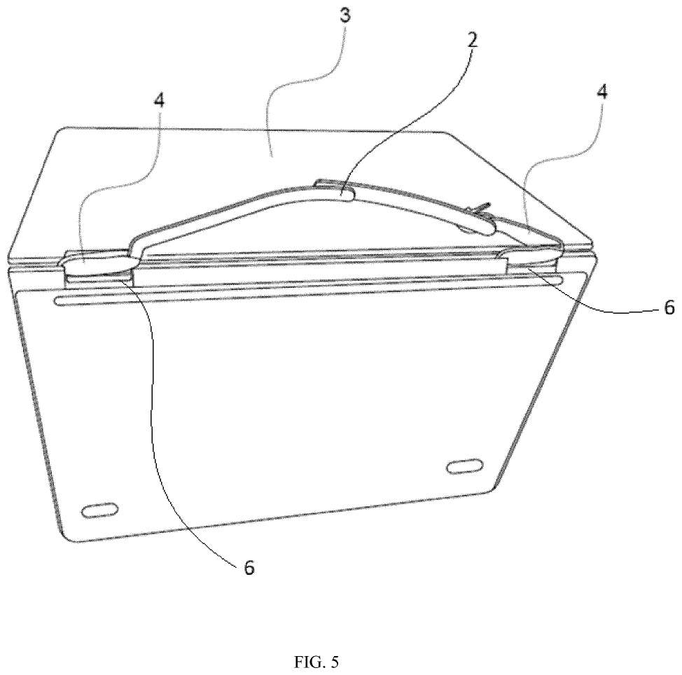

FIG. 6 In accordance with a preferred embodiment of the present invention, the mobile device holder is shown with a user's hand slid between the mobile device and the mobile device holder to securely hold the mobile device. A user may adjust their fingers on either side of the mobile device holder to provide added grip or stability.

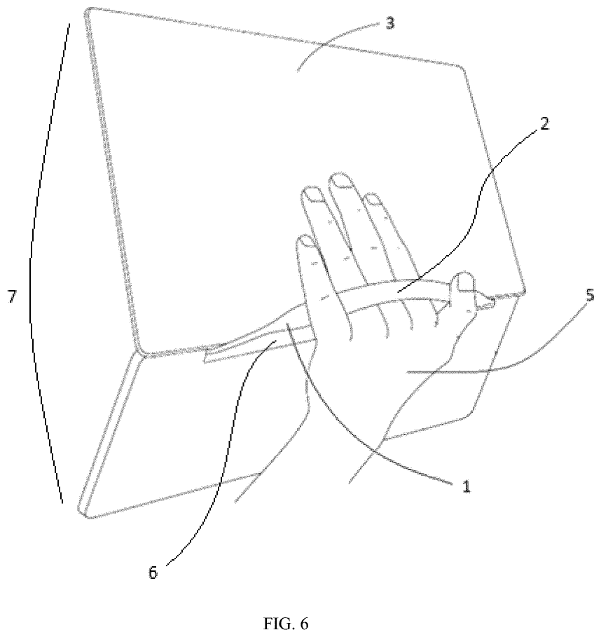

FIG. 7 In accordance with a preferred embodiment of the present invention, the mobile device holder is shown with a user's hand slid between the mobile device and the mobile device holder to securely carry the mobile device, like carrying a briefcase.

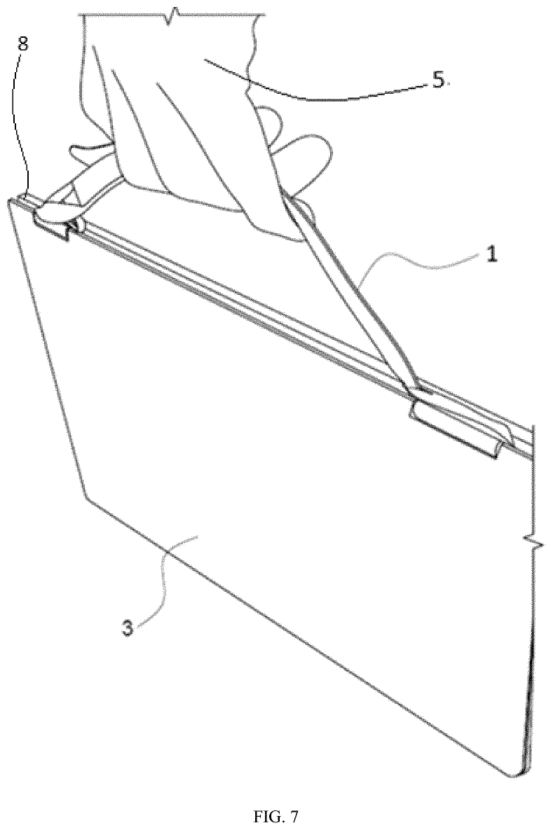

### DETAILED DESCRIPTION

The mobile device holder (1) encircles the hinge(s) (6) of a mobile device to allow a user to securely hold or carry a mobile device with one hand or one arm (5).

The mobile device holder fits securely around the hinge(s) from the front to the back or from back to the front of the mobile device with minimal or no obstructions to opening (7) or closing (8) the mobile device. The invention may allow for adjustments (2) to the size of the enclosed loop to accommodate for varying user's hand or finger sizes.

The invention may be a fully enclosed seamless loop without enclosures or an open loop with enclosures to form a fully closed loop around the hinge(s) of the mobile device.

The mobile device holder is preferably used by sliding a hand between the mobile device holder and the mobile device while standing or walking, but not limited to, to provide the user a secure hold of the mobile device. The mobile device can be open (7) or closed (8) around the hinge(s) (6) in which case a user may securely hold or carry the mobile device using the invention. A user may hold the mobile device by adjusting their fingers on either side of the mobile device holder to provide added grip or stability.

The mobile device is preferably used by fully or partially opening or closing the mobile device around the hinge as far forward or backward as the mobile device allows, exposing either the front or back part of the mobile device holder for use by a user to securely hold or carry the mobile device with their hand.

The user may securely fit the mobile device holder with the enclosure on the front or back of the mobile device but is not limited to this option of securely fitting the mobile device holder onto the mobile device.

The present invention can be securely latched onto the mobile device of a single hinge (6). Since the single hinge (6) is shorter in length than the mobile device (3), the invention can resist from sliding off the mobile device.

The present invention can be securely latched onto the mobile device of multiple hinges, either by encircling the outer hinges (1) or by encircling specific hinge(s) (4) individually. Alternately, the present invention can be secured around the outer hinges of a multiple hinge mobile device, similar to a single hinge mobile device.

The preferred embodiment of the present invention, is to securely fit the invention around the hinge(s) of a mobile device, such as a laptop computer or a folding mobile phone, but not limited to, and sliding a hand between the mobile device holder and the back of the laptop or mobile phone with or without individual fingers on either side of the mobile device holder to securely hold the laptop or mobile phone to provide the user a secure hold of the mobile device. The mobile device can be open (7) or closed (8) around the hinge(s) (6), exposing the back of the laptop allowing the invention to be used for carrying, like a briefcase, with one hand (5) when holding the invention, similar to a carrying a briefcase and holding its handle A user may adjust their fingers on either side of the mobile device holder to provide added grip or stability.

The invention may be made of polyester or nylon but not limited to these materials.

The invention is typically made of a strong thin narrow pliant material but is not limited to these dimensions. The mobile device holder may vary in size based on the size and design of the mobile device.

The invention may latch onto or around the hinge(s) (6) of the mobile device by an enclosed strap or by clamps but is not limited to these methods.

The invention may use hook and loop, hooks, buckles, ladders, or buttons for the enclosure (2) of the mobile device holder but is not limited to these enclosure devices or methods. An enclosure (2) may not be required when the mobile device holder is a single seamless closed piece of material loop, while having the ability for adjustments of length to form a secure fit around the hinge(s) of the mobile device and a user's hand or fingers.

What is claimed is:

1. A mobile device holder for securely holding or carrying mobile devices, comprising:

1. A strap with or without enclosures to form a loop to be secured around the hinge(s) of a mobile device

2. The strap of claim 1 allowing a user to securely hold a mobile device while it is open or closed around the mobile device hinge(s)

3. The strap of claim 1 is formed of strong thin flexible material about 0.2 mm to 10 mm thick, about 0.5 mm to 20 mm wide and about 10 cm to 92 cm long.

4. A strap of claim 1 is minimally obstructive to prevent the mobile device from not opening or closing around the hinge(s).

5. A strap of claim 1 with enclosure of a hook and loop fastener that can be adjusted to shorten or extend the length of the strap to allow for a secure fit around a user's hand

6. A strap of claim 1 with no enclosures and formed of a single seamless circular strap that can be adjusted to shorten or extend the length of the strap using attached hook and loop fasteners to allow for a secure fit around a user's hand

7. A method comprising the steps of:
attaching a strap securely around the mobile device's single hinge, multiple hinges, or the outer hinges and using the resistance between the shorter outer length of hinge(s) and the mobile device case body for the mobile device holder to securely hold onto the mobile device; securely enclosing the strap with hook and loop fasteners;
selectively adjusting the strap length by detaching the hook and loop fasteners; and
selectively reattaching the hook and loop fastener to the desired length of the strap

8. The method of claim 7 wherein the mobile device can be held securely while it is partially open with a hand or fingers

9. The method of claim 7 wherein the mobile device can be carried securely while it is fully open or closed, as far forward or backward around the hinge(s) as possible, with a hand or fingers
